(19) United States
(12) Patent Application Publication
(10) Pub. No.: US 2008/0017049 A1
(43) Pub. Date: Jan. 24, 2008

(54) Egg cracking device

(76) Inventor: Miles O'Connor, Las Vegas, NV (US)

Correspondence Address: Henry C. Query, Jr., 504 S. Pierce Avenue, Wheaton, IL, 60187, US

(21) Appl. No.: 11/491,324

(22) Filed: Jul. 21, 2006

(51) Int. Cl. A23L 1/015

(52) U.S. Cl. 99/484

(57) ABSTRACT

A device for cracking the shell of an egg comprises a top which includes an ellipsoidal support surface, a structure for supporting the top above a work surface, and a cutting member which is disposed along the lateral axis of the support surface. The length of the cutting member along the lateral axis of the support surface is between about 30% and 100% of the lateral width of the support surface. Thus, when the equator of the egg is aligned with the lateral axis of the support surface and forced against the cutting member, the cutting member will create and propagate a fracture around the shell while the shell is supported by the support surface.

### BACKGROUND OF THE INVENTION

The present invention relates to a device for cracking the shells of uncooked eggs. More particularly, the invention relates to an egg cracking device which comprises an elongated cutting member which, in use, produces a relatively uniform fracture around the equator of the shell.

The prior art is replete with various devices which are used to crack the shells of eggs. One such device is shown in U.S. Pat. No. 3,494,397 to Sparks. The egg cracker described in this patent comprises an ellipsoid-shaped recess and a pair of spaced-apart, wedge-shaped eggshell fracturing members that are positioned along the lateral axis of the recess. In use, the eggshell fracturing members create two distinct punctures in the egg shell which are interconnected by a hairline crack. However, this device does not appear to be effective in propagating the hairline crack around the periphery of the egg. In addition, the eggshell fracturing members would appear to extend a considerable distance into the egg, and this could damage the yoke.

### SUMMARY OF THE INVENTION

In accordance with the present invention, these and other limitations in the prior art are overcome by providing a novel and effective device for cracking the shell of an uncooked egg. The device includes a top which comprises an ellipsoidal support surface, means for supporting the top above a work surface, and a cutting member which is disposed along the lateral axis of the support surface. The length of the cutting member along the lateral axis of the support surface is between about 30% and 100% of the lateral width of the support surface. In addition, the maximum height of the cutting member is ideally limited to about 0.430 inch or less. Thus, when the equator of the egg is aligned with the lateral axis of the support surface and forced against the cutting member, the cutting member will penetrate just the shell and propagate a fracture around the shell while the shell is supported by the support surface.

Thus, the egg cracking device of the present invention provides an effective an efficient means for cracking the shell of an egg. Since the support surface supports the shell as the cutting member propagates the fracture, the likelihood that errant fractures will form in the shell is substantially reduced. In addition, since the maximum height of the cutting member is limited, the cutting member will not damage the yoke.

These and other objects and advantages of the present invention will be made apparent from the following detailed description, with reference to the accompanying drawings. In the drawings, the same reference numbers are used to denote similar components in the various embodiments.

### BRIEF DESCRIPTION OF THE DRAWINGS

FIG. 1 is a perspective view of an exemplary embodiment of the egg cracking device of the present invention;

FIG. 2 is a top plan view of the egg cracking device shown in FIG. 1;

FIG. 3 is a side elevation view of the egg cracking device shown in FIG. 1;

FIG. 4 is an exploded front elevation view of the egg cracking device shown in FIG. 1;

FIGS. 5A through 5C are cross sectional views of various embodiments of the cutting member of the egg cracking device shown in FIG. 1;

FIGS. 6A through 6C are perspective views of the egg cracking device of FIG. 1 shown being used to crack the shell of an egg; and

FIG. 7 is a representation of another embodiment of the egg cracking device of the present invention.

### DETAILED DESCRIPTION OF THE INVENTION

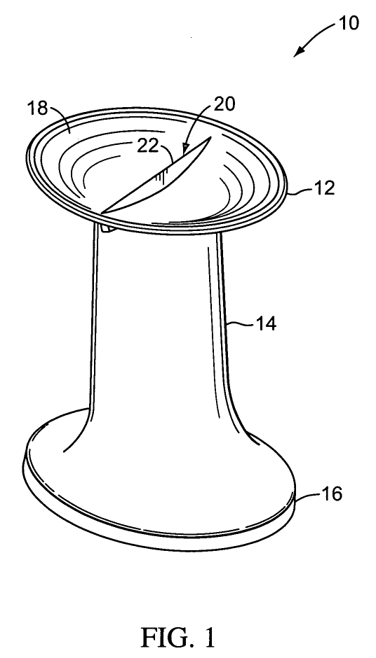

Referring to FIGS. 1 through 4, the egg cracking device of the present invention, which is indicated generally by reference number 10, is shown to comprise a top 12, an elongated neck 14 which depends downwardly from the top, and a base 16 which extends transversely from the bottom of the neck. The top 12, the neck 14 and the base 16 may be made of any suitable material, such as a plastic material. In addition, although these components may be formed separately and then joined to each other by appropriate means, in a preferred embodiment of the invention they are formed integrally with each other in one or more molding operations.

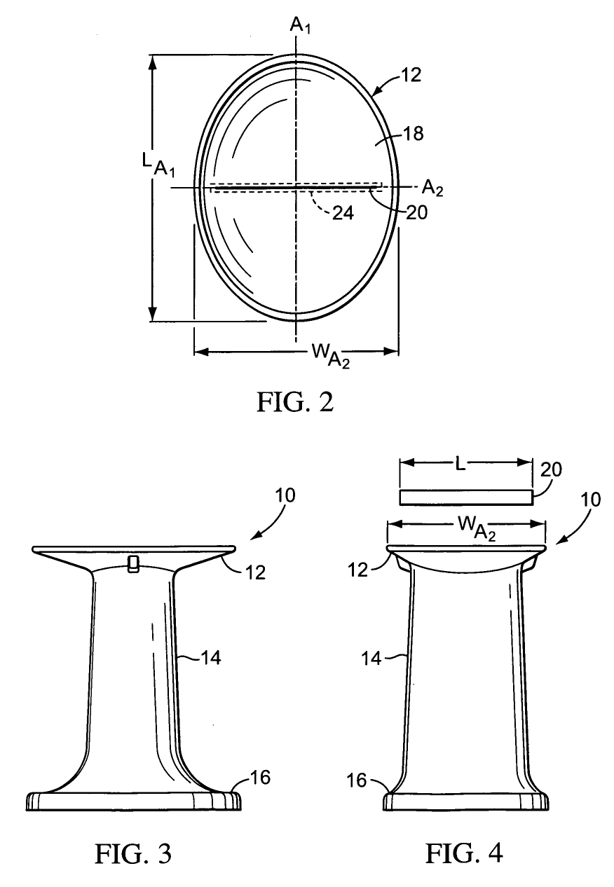

The top 12 includes a generally ellipsoidal support surface 18 which as shown in FIG. 2 comprises a longitudinal axis A₁ and a lateral axis A₂. The size and shape of the support surface 18 are chosen to conform to an average size egg. In this manner, the support surface 18 will support a substantial portion of the surface of the egg during use of the egg cracking device 10. This in turn will reduce the likelihood that errant fractures will form in the shell as it is being cracked.

The length of the neck 14 is chosen so as to position the top 12 a comfortable distance above a work surface, such as a stove or a kitchen countertop. For example, the neck may be between about 2″ and 4″ long. More preferably, the neck is about 3″ long. In addition, the size of the base 16 is selected to provide a stable support for both the top 12 and the neck 14. Ideally, the base 16 comprises a longitudinal axis which is aligned with the longitudinal axis A₁ of the support surface. In addition, the length of the base 16 along its longitudinal axis may be approximately equal to or greater than the longitudinal length L_{A1} of the support surface 18. For example, the base may comprise a generally elliptical configuration having approximately the same size as the top 12, with its longitudinal and lateral axes aligned with the longitudinal and lateral axes A₁, A₂ of the support surface 18. In this manner, the base 16 will be able to counter any bending moments which are created in the neck 14 during use of the egg cracking device 10.

In accordance with the present invention, the egg is fractured, or cracked, by means of a cutting member 20 which is located on the top 12. In a preferred embodiment of the invention, the cutting member 20 is oriented along the lateral axis A₂ of the support surface 18. In addition, for reasons which will be made apparent below, the cutting member 20 ideally comprises a length L which is a substantial percentage of the lateral width W_{A2} of the support surface 18. For example, the length L of the cutting member 20 may be between about 30% and 100% of the width W_{A2} of the support surface 18. More preferably, the length L of the cutting member may be between about 60% and 95% of the width W_{A2} of the support surface 18. Most preferably, the length L of the cutting member is about 80% of the width W_{A2} of the support surface 18. Thus, the cutting member 20 extends a substantial distance across the lateral axis A₂ of the support surface 18.

In addition, the cutting member 20 preferably comprises a top edge 22 which is roughly straight. Consequently, as shown most clearly in FIG. 1, the height of the cutting member 20 relative to the support surface 18 is greatest at the lateral middle of the support surface, and the height tapers to approximately zero at the ends of the cutting member. Furthermore, the maximum height of the cutting member 20 is ideally minimized so as not to damage the yoke during use of the egg cracking device 10. For example, the maximum height of the cutting member 20 may be about 0.430 inch or less.

In an exemplary embodiment of the invention, the cutting member 20 is made of a suitable plastic or metallic material and is mounted in an elongated slot 24 which is formed in the support surface 18. In another embodiment of the invention which is not illustrated in the Figures, the cutting member 20 is made of a suitable plastic material and is formed integrally with the head 12 in a single molding operation.

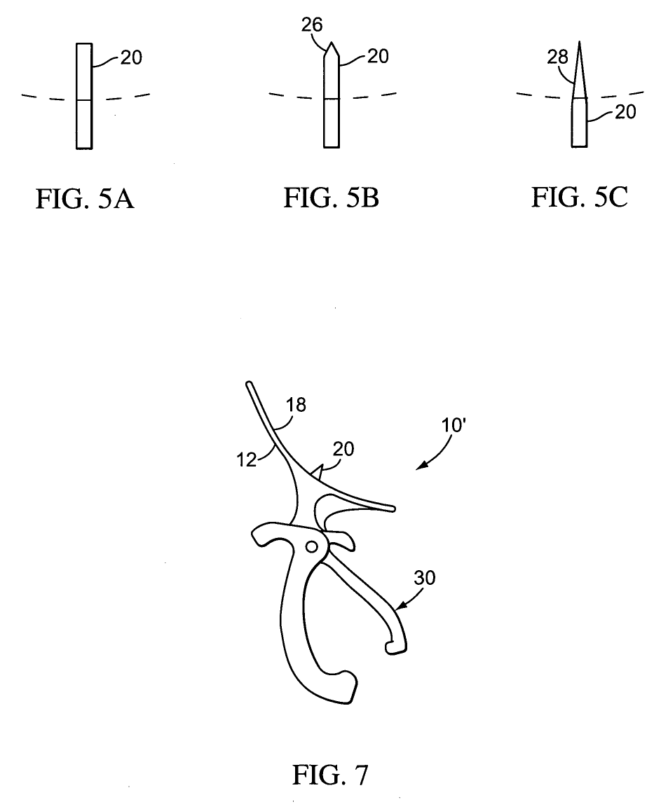

Three embodiments of the cutting member 20 are shown in FIGS. 5A through 5C, each with a different cross sectional configuration. In FIG. 5A, the cutting member 20 is shown to comprise a generally rectangular cross sectional configuration. In FIG. 5B, the cutting member 20 is shown to comprise a generally rectangular cross sectional configuration having a triangular top portion 26. In FIG. 5C, the cutting member 20 is shown to comprise a generally triangular cross sectional configuration having a base 28 which is located proximate the support surface 18, which is shown schematically in phantom in FIGS. 5A through 5C. In each of these embodiments, the maximum thickness of the cutting member 20 is about 0.024 inch. Each of these cross sectional configurations is effective in creating and propagating a desired fracture in the shell without causing undue damage to the egg.

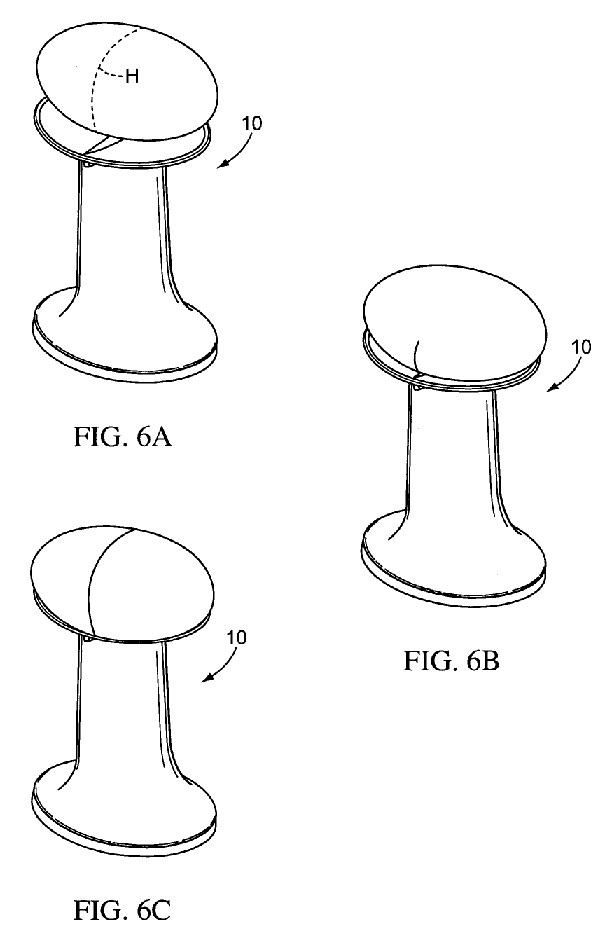

The use of the egg cracking device 10 to crack the shell of an egg is illustrated in FIGS. 6A through 6B. Initially, a person grasps the egg, aligns the equator H of the shell with the lateral axis A₂ of the support surface 18, and forces the egg down against cutting member 20 (FIG. 6A). This action causes the center of the cutting member 20 to fracture a small segment of the shell. When the egg is further pressed against the cutting member 20, the central portion of the cutting member will cause this initial fracture to propagate approximately one-third to one-half around the equator H of the shell (FIG. 6B). Finally, as the egg is pressed into contact with the support surface 18, the ends of the cutting member 20 will cause this fracture to propagate substantially around the equator H of the shell, thereby separating the shell into two halves (FIG. 6C). As a result, the shell can be easily separated and the yoke can be cleanly removed.

Another embodiment of the egg cracking device of the present invention is shown in FIG. 7. The egg cracking device of this embodiment, which is indicated generally by reference number 10′, is similar in many respects to the embodiment described above. Thus, the egg cracking device 10′ comprises a head 12 which includes a support surface 18 in which a cutting member 20 is disposed. However, instead of the neck 14 and the base 16 of the previous embodiment, the head 12 of the egg cracking device 10′ of the present embodiment is connected to or formed integrally with a clamp 30. The clamp 30 in turn is removably attachable to the edge of a pan, a bowl or the like to support the egg cracking device 10′ a comfortable distance above a work surface, such as a stove or a kitchen countertop. Thus, the clamp 30 allows the egg cracking device 10′ to be placed close to where the egg yoke will be deposited after the shell has been removed.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

I claim:

1. A device for cracking the shell of an egg which comprises:
a top which includes an ellipsoidal support surface having a longitudinal axis, a lateral axis, a longitudinal length and a lateral width;
means for supporting the top above a work surface; and
a cutting member which is disposed along the lateral axis of the support surface;
wherein the length of the cutting member along the lateral axis of the support surface is between about 30% and 100% of the lateral width of the support surface; and
wherein, when the equator of the egg is aligned with the lateral axis of the support surface and forced against the cutting member, the cutting member will create and propagate a fracture around the shell while the shell is supported by the support surface.

2. The device of claim 1, where the length of the cutting member along the lateral axis of the support surface is between about 60% and 95% of the lateral width of the support surface.

3. The device of claim 1, where the length of the cutting member along the lateral axis of the support surface is about 80% of the lateral width of the support surface.

4. The device of claim 1, wherein the cutting member comprises an upper edge which is substantially straight.

5. The device of claim 4, wherein the height of the cutting member relative to the support surface is a maximum proximate the lateral middle of the support surface.

6. The device of claim 5, wherein the height of the cutting member relative to the support surface tapers to approximately zero at the ends of the cutting member.

7. The device of claim 5, wherein the maximum height of the cutting member is approximately 0.430 inch or less.

8. The device of claim 1, wherein the cutting member comprises a generally rectangular cross sectional configuration.

9. The device of claim 1, wherein the cutting member comprises a generally rectangular cross sectional configuration having a triangular top portion.

10. The device of claim 1, wherein the cutting member comprises a generally triangular cross sectional configuration having a base which is located proximate the support surface.

11. The device of claim 1, wherein the cutting member is mounted in a slot which is formed in the support surface.

12. The device of claim 1, wherein the cutting member is formed integrally with the support surface.

13. The device of claim 1, wherein the supporting means comprises a neck which depends downwardly from the head and a base which extends transversely from the bottom of the neck.

14. The egg cracking device of claim 13, wherein the base comprises a longitudinal axis which is aligned with the longitudinal axis of the support surface.

15. The egg cracking device of claim 13, wherein the length of the longitudinal base along its longitudinal axis is approximately equal to or greater than the longitudinal length of the support surface.

16. The device of claim 1, wherein the supporting means comprises a clamp.
